(19) United States
(12) Patent Application Publication
(10) Pub. No.: US 2024/0387927 A1
(43) Pub. Date: Nov. 21, 2024

(54) BATTERY PACK FOR VEHICLES

(71) Applicants: HYUNDAI MOTOR COMPANY, Seoul (KR); KIA CORPORATION, Seoul (KR)

(72) Inventors: Yu Ri Oh, Hwaseong-si (KR); Young Hoo Oh, Daejeon (KR); In Gook Son, Incheon (KR); Seok Eun Yoon, Seoul (KR)

(73) Assignees: HYUNDAI MOTOR COMPANY, Seoul (KR); KIA CORPORATION, Seoul (KR)

(21) Appl. No.: 18/376,288

(22) Filed: Oct. 3, 2023

(30) Foreign Application Priority Data
May 16, 2023 (KR) 10-2023-0063125

(51) Int. Cl. H01M 50/249; B60K 1/04; H01M 50/244; H01M 50/262; H01M 50/291

(52) U.S. Cl. CPC H01M 50/249; B60K 1/04; H01M 50/244; H01M 50/262; H01M 50/291; B60K 2001/0438; H01M 50/242

(57) ABSTRACT

A battery pack for vehicles includes: a lower case with a module accommodation space defined therein to accommodate a plurality of battery modules; at least one longitudinal member provided in the module accommodation space in the lower case and arranged to be elongate in a forward-rearward direction; and a mounting through-hole formed in the at least one longitudinal member to allow a through-bolt to be inserted therethrough to mount the battery pack.

### CROSS-REFERENCE TO RELATED APPLICATION

This application claims the benefit of and priority to Korean Patent Application No. 10-2023-0063125, filed on May 16, 2023 in the Korean Intellectual Property Office, the entire disclosure of which is incorporated herein by reference.

### BACKGROUND OF THE DISCLOSURE

### 1. Technical Field

The present disclosure relates to technology for the structure of a battery pack mounted in a vehicle.

### 2. Description of the Related Art

In general, a battery pack for supplying power to a driving motor is mounted in an electric vehicle or the like.

The battery pack includes a plurality of battery modules and a battery case enveloping the battery modules. Each battery module includes a plurality of battery cells.

The battery case includes a lower case or pan covering the lower sides and the side surfaces of the battery modules. The battery case also includes an upper cover covering the upper side of the lower case to accommodate the battery modules in an inner space defined between the lower case and the upper case.

The lower case is provided on both side surfaces thereof with battery side members. The battery side members are provided with mounting portions that are coupled to a vehicle body and that serve to absorb impact caused by side collision of a vehicle.

The information disclosed in this Background of the Disclosure section is only to enhance understanding of the general background of the disclosure. This section should not be taken as an acknowledgement or any form of suggestion that this information forms the related art already known to a person of ordinary skill in the art.

### SUMMARY OF THE DISCLOSURE

Therefore, the present disclosure has been made in view of the above problems. It is an object of the present disclosure to provide a battery pack configured to be mounted on the lower side of a vehicle and to form an appropriate load path for impact in the event of collision of the vehicle in a forward-backward direction or the like. Battery modules accommodated in the battery pack are thereby more reliably protected.

In accordance with an aspect of the present disclosure, the above and other objects can be accomplished by the provision of a battery pack for vehicles. The battery pack includes a lower case having a module accommodation space defined therein to accommodate a plurality of battery modules. The battery pack also includes at least one longitudinal member provided in the module accommodation space in the lower case and arranged to be elongate in a forward-rearward direction. The battery pack also includes a mounting through-hole formed in the at least one longitudinal member to allow a through-bolt to be inserted therethrough for mounting or securing the battery pack.

The battery pack may further include a transverse member provided in the module accommodation space in the lower case and arranged in a direction perpendicular to the at least one longitudinal member. The mounting through-hole may be formed in the at least one longitudinal member but not the transverse member.

The battery pack may further include a through pipe mounted in the mounting through-hole. The through pipe may be formed to allow the through-bolt to pass therethrough in order to support fastening force of the through-bolt.

The module accommodation space in the lower case may be formed in a rectangular parallelepiped shape. The at least one longitudinal member may be mounted so as to be connected between a front surface of the module accommodation space and a rear surface of the module accommodation space.

The lower case may include an extension space defined therein at at least one of a position ahead of the module accommodation space or a position behind the module accommodation space. The extension space may be a separate space extending forward or rearward from the module accommodation space.

The lower case may include battery side members provided on both sides of the module accommodation space. The battery side members may be connected at end portions thereof to a peripheral member provided to define the extension space.

In accordance with another aspect of the present disclosure, a vehicular battery pack mounting structure is provided. The mounting structure includes a lower case having a module accommodation space defined therein to accommodate a plurality of battery modules. The mounting structure also includes at least one longitudinal member provided in the module accommodation space in the lower case and arranged to be elongate in a forward-rearward direction. The mounting structure also includes at least one cross-member of a vehicle body arranged to be elongate in a transverse direction of the vehicle body. The mounting structure also includes a through-bolt fastened through the at least one longitudinal member and the at least one cross-member for mounting or securing the battery pack.

The mounting structure may further include a mounting through-hole formed in the at least one longitudinal member to allow the through-bolt to be inserted therethrough and may include a through pipe mounted in the mounting through-hole. The through pipe may be formed to allow the through-bolt to pass therethrough in order to support fastening force of the through-bolt.

The mounting structure may further include a transverse member provided in the module accommodation space in the lower case and arranged in a direction perpendicular to the at least one longitudinal member. The mounting through-hole may be formed in the at least one longitudinal member.

The at least one cross-member may include a seat cross-member provided for mounting of a seat. The through-bolt may be fastened through the seat cross-member.

The seat cross-member may be mounted above a floor panel of the vehicle body. The mounting structure may further include a weld nut fixedly provided between the seat cross-member and the floor panel. The through-bolt may be fastened to the weld nut.

The module accommodation space in the lower case may be formed in a rectangular parallelepiped shape. The at least one longitudinal member may be mounted so as to be connected between a front surface of the module accommodation space and a rear surface of the module accommodation space.

The lower case may include an extension space defined therein at at least one of a position ahead of the module accommodation space or a position behind the module accommodation space. The extension space may be a separate space extending forward or rearward from the module accommodation space.

The lower case may include battery side members provided on both sides of the module accommodation space. The battery side members may be connected at end portions thereof to a peripheral member provided to define the extension space. The battery side members may include a plurality of side mounting holes formed therein to be coupled to the vehicle body.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a view showing a lower case of a battery pack according to the present disclosure;

FIG. 2 is a plan view of the lower case shown in FIG. 1;

FIG. 3 is a view illustrating coupling of the lower case shown in FIG. 1 to a vehicle body;

FIG. 4 is a view of the cross-sectional structure taken along line IV-IV in FIG. 2; and

FIG. 5 is a graph showing a difference in support strength between the battery pack according to the present disclosure and a conventional art as a result of an offset collision test.

### DETAILED DESCRIPTION OF EMBODIMENTS

Hereinafter, the embodiments disclosed in the present specification are described in detail with reference to the accompanying drawings. The same or similar elements are denoted by the same reference numerals even though they are depicted in different drawings, and redundant descriptions thereof have been omitted.

In the following description, with respect to constituent elements used in the following description, the suffixes “module” and “unit” are used only to help facilitate the description, and do not have mutually distinguished meanings or functions.

In the following description of the embodiments disclosed in the present specification, a detailed description of known functions and configurations incorporated herein has been omitted where the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It should be understood that, although the terms “first”, “second”, etc., may be used herein to describe various components, these components should not be limited by these terms. These terms are only used to distinguish one component from another component.

It should be understood that, when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular forms are intended to include the plural forms as well, unless the context clearly indicates otherwise. When a component, device, element, or the like of the present disclosure is described as having a purpose or performing an operation, function, or the like, the component, device, or element should be considered herein as being “configured to” meet that purpose or perform that operation or function.

It should be further understood that the terms “comprises”, “comprising”, “has”, “having”, “includes”, and/or “including” and variations thereof, when used herein, specify the presence of stated features, integers, steps, operations, elements, components, or combinations thereof. Such terms do not preclude the presence or addition of one or more other features, integers, steps, operations, elements, components, or combinations thereof.

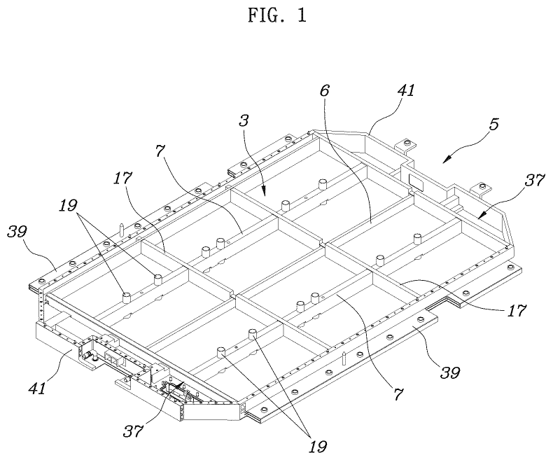

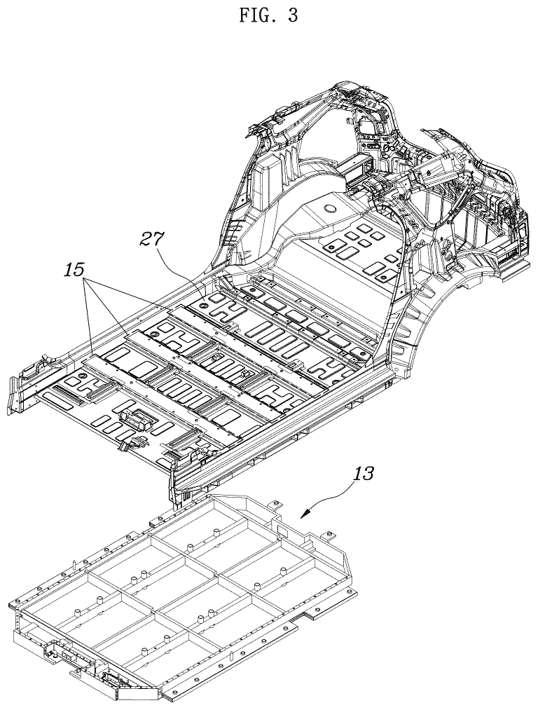

Referring to FIGS. 1-4, a battery pack according to an embodiment of the present disclosure includes a lower case 5. The lower case 5 includes a module accommodation space 3 defined therein to accommodate a plurality of battery modules 1. The lower case 5 also includes at least one longitudinal member 7, which is provided in the module accommodation space 3 in the lower case 5 and is arranged or oriented to be elongate in a forward-rearward direction. The lower case also includes a mounting through-hole 11 formed in the longitudinal member 7 to allow a through-bolt 9 to be inserted therethrough for mounting or securing a battery. As shown in FIGS. 1-4, the at least one longitudinal member 7 may include two or more, i.e., a plurality, of the longitudinal members 7. Further, the through-hole 11 for mounting the battery pack may include two or more, i.e., a plurality, of the mounting through-holes 11.

In detail, the module accommodation space 3 accommodates the plurality of battery modules 1 and is defined in the battery pack 13 according to the present disclosure. The at least one longitudinal member 7 is provided in the module accommodation space 3 so as to be elongate in the forward-rearward direction. The through-bolt 9 is fastened through the longitudinal member 7 to mount the battery pack 13 to a vehicle body. Accordingly, in the event of a collision of the vehicle body in the forward-rearward direction, the longitudinal member 7 forms a load path for impact, thereby effectively supporting and protecting the battery modules 1 accommodated in the module accommodation space 3.

Here, the forward-rearward direction is a forward-rearward direction of the vehicle body of a vehicle in which the battery modules 1 are mounted.

The battery mounting through-bolt 9 may be coupled to a cross-member 15 or the like provided in or on the vehicle body in order to secure strong fastening force and a stable load supporting state.

In this embodiment, a transverse member 17 is provided in the module accommodation space 3 in the lower case 5 and is arranged or oriented in a direction perpendicular to the longitudinal member 7. The mounting through-hole 11 is formed only in the longitudinal member 7.

Therefore, even if the cross-member 15 of the vehicle body, to which the through-bolt 9 is coupled, is disposed to be elongate in the forward-rearward direction of the vehicle body, it is possible to easily change the fastening position of the through-bolt 9 while securing strong fastening force of the through-bolt 9 and a stable load supporting state.

Therefore, it is possible to easily apply the battery pack 13 of the present disclosure to various types of vehicles, which have cross-members disposed at different positions on a vehicle body. Further, it is possible to appropriately secure firm coupling of the battery pack 13 to the vehicle body and to effectively protect the battery modules 1 from impact applied to the vehicle in the forward-rearward direction.

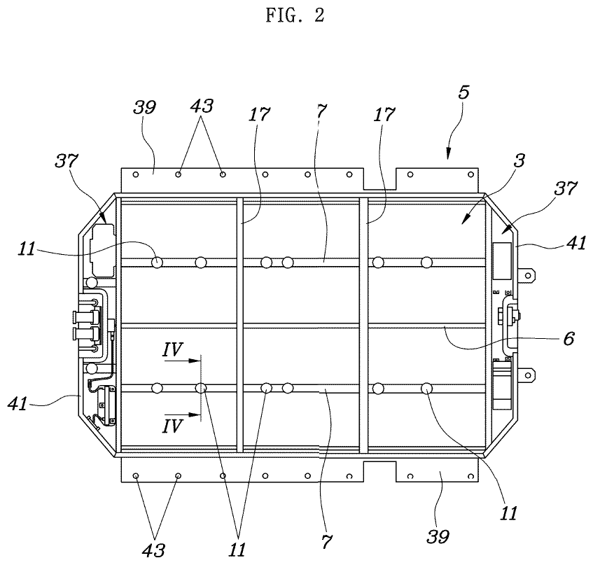

Referring to FIG. 2, two longitudinal members 7 and a plurality of transverse members 17 are provided. A plurality of mounting through-holes 11 is formed in the mounting structure, but only in the longitudinal members 7.

A through pipe member, i.e., a through pipe 19 is mounted in each of the mounting through-holes 11. The through pipe 19 is formed and disposed to allow the through-bolt 9 to pass therethrough in order to support fastening force of the through-bolt 9.

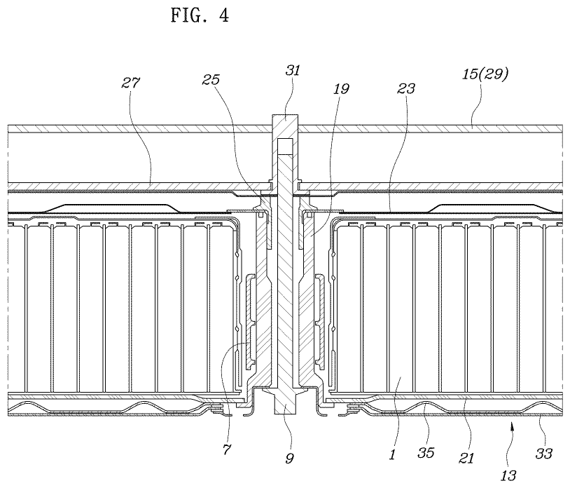

In an example, as shown in FIG. 4, the through pipe 19 is mounted so as to interconnect and support a base plate or pan 21 and an upper cover 23. The base plate 21 is provided at the lower case 5 in order to support the lower sides of the battery modules 1. The upper cover 23 covers the upper side of the lower case 5 in order to isolate the battery modules 1 from the outside. The upper side of the through pipe 19 is fixed to the upper cover 23 by means of a hollow nut 25.

A floor panel 27 of the vehicle body is located above the battery pack 13. A seat cross-member 29, which is a kind of vehicle body cross-member 15, is provided above the floor panel 27.

A weld nut 31 is provided between the seat cross-member 29 and the floor panel 27. The through-bolt 9 penetrates the battery pack 13 and is fastened to the weld nut 31.

The bolt head of the through-bolt 9 supports the lower side of the through pipe 19 through a lower cover 33 of the battery pack 13. Thus, the through pipe 19 supports the fastening force of the through-bolt 9.

A cooling plate 35, which forms a cooling path for cooling of the battery modules 1, is provided between the lower cover 33 and the base plate 21 of the battery pack 13. Therefore, the lower cover 33 defines the lower periphery of the battery pack 13 while covering the lower side of the cooling plate 35.

In this embodiment, the module accommodation space 3 in the lower case 5 is formed in a rectangular parallelepiped shape. The longitudinal member 7 is mounted so as to be connected between the front surface and the rear surface of the lower case 5 defining module accommodation space 3.

An extension space 37 is defined in the lower case 5 and is located at a position ahead of the module accommodation space 3, a position behind the module accommodation space 3, or both positions. The extension space 37 is a separate space extending forward and/or rearward from the module accommodation space 3.

In this embodiment, extension spaces 37 are defined in the lower case 5 both at a position ahead of the module accommodation space 3 and at a position behind the module accommodation space 3 in order to accommodate various components, such as a battery management system (BMS), a primary relay assembly (PRA), or the like.

Battery side members 39 are provided on both sides of the module accommodation space 3 in the lower case 5. The battery side members 39 are connected at end portions thereof to peripheral members 41 provided to define the extension spaces 37.

Therefore, when an impact is applied to the battery pack 13 in the forward-rearward direction of the vehicle body, the extension spaces 37 first collapse to absorb the impact. Thereafter, the longitudinal member or members 7 form a load path for the impact. The battery modules 1 in the module accommodation space 3 are thereby supported, thus greatly reducing the possibility of damage to the battery modules 1 in the event of a collision impact.

In this embodiment, a center longitudinal member 6 is disposed at the center of the lower case 5. The center longitudinal member 6 extends in the forward-rearward direction. Longitudinal members 7 are disposed on both sides of the center longitudinal member 6 and also extend in the forward-rearward direction. A plurality of through pipes 19 is provided, but again only on the longitudinal members 7.

The center longitudinal member 6 forms a load path for an impact applied to the battery pack 13 in the forward-rearward direction together with the other longitudinal members 7. The longitudinal members 6 and 7 serve not only to support the battery modules 1 but also to provide surface pressure to the battery modules 1.

For reference, battery cells constituting each battery module 1 may be stacked in the transverse direction of the battery pack 13. The battery modules 1 may also be loaded in the lower case 5 in the transverse direction of the battery pack 13.

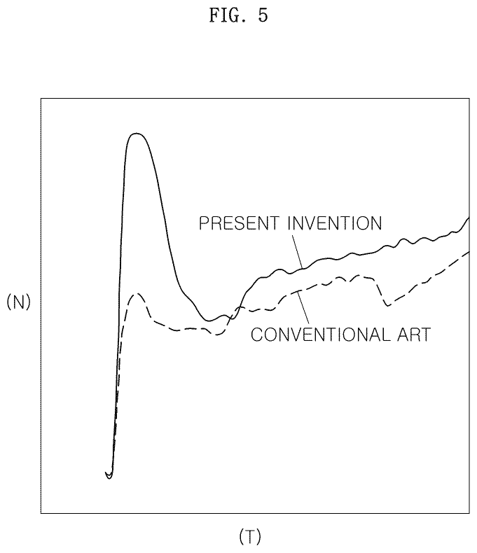

FIG. 5 is a graph showing a difference in support strength between a battery pack constructed according to the present disclosure, in which the battery modules 1 are loaded in the transverse direction and the center longitudinal member 6 and the longitudinal members 7 are provided, and a conventional battery pack construction as a result of an offset collision test. As can be seen from FIG. 5, the present disclosure exhibits much higher support strength than the conventional art.

Here, the offset collision test is a collision test in which an impact is applied to a portion of the vehicle body, offset to one side of the center line of the vehicle body or the battery pack.

Hereinafter, a structure for mounting the battery pack 13 of the present disclosure, configured as described above, to a vehicle body is described.

A vehicular battery pack mounting structure, i.e., a mounting structure according to the present disclosure, includes a lower case 5, which has a module accommodation space 3 defined therein to accommodate a plurality of battery modules 1. The mounting structure also includes at least one longitudinal member 7, which is provided in the module accommodation space 3 in the lower case 5 and arranged to be elongate in the forward-rearward direction. The mounting structure also includes at least one cross-member 15 of a vehicle body, where the cross-member 15 is mounted to be elongate in the transverse direction of the vehicle body. The mounting structure also includes a through-bolt 9, which is fastened both through the longitudinal member 7 and through the vehicle body cross-member 15 to mount or secure a battery back to the vehicle body.

A mounting through-hole 11 is formed in the longitudinal member 7 to allow the through-bolt 9 to be inserted therethrough. A through pipe 19 is mounted in the mounting through-hole 11. The through pipe 19 is formed and disposed to allow the through-bolt 9 to pass therethrough in order to support fastening force of the through-bolt 9.

A transverse member 17 is provided in the module accommodation space 3 in the lower case 5 and arranged in a direction perpendicular to the longitudinal member 7. The mounting through-hole 11 is formed only in the longitudinal member 7.

The cross-member 15 of the vehicle body, through which the through-bolt 9 is fastened, may be a seat cross-member 29 configured to mount a seat to the vehicle body.

The seat cross-member 29 is mounted above a floor panel 27 of the vehicle body. A weld nut 31 is fixedly provided between the seat cross-member 29 and the floor panel 27 and the through-bolt 9 is fastened to the weld nut 31.

The module accommodation space 3 in the lower case 5 is formed in a rectangular parallelepiped shape. The longitudinal member 7 is mounted so as to be connected between the front surface and the rear surface of the lower case 5 defining the module accommodation space 3.

An extension space 37 is defined in the lower case 5 and is located at a position ahead of the module accommodation space 3, a position behind the module accommodation space 3, or both. The extension space 37 is a separate space extending forward or rearward from the module accommodation space 3.

Battery side members 39 are provided on both sides of the module accommodation space 3 in the lower case 5. The battery side members 39 are connected at end portions thereof to a peripheral member 41 provided to define the extension space 37. The battery side members 39 include a plurality of side mounting holes 43 formed therein. The side mounting holes 43 are to be used to couple the battery side members 39, and thus the lower case 5 and the battery pack 13 to the vehicle body.

Accordingly, the battery pack 13 may be firmly mounted to the vehicle body through the side mounting holes 43 in the battery side members 39 and the mounting through-holes 11 in the longitudinal members 7.

As should be apparent from the above description, the present disclosure provides a battery pack configured to be mounted on the lower side of a vehicle and to form an appropriate load path for an impact in the event of a collision of the vehicle in a forward-rearward direction or the like. Thus, the battery back more reliably protects battery modules accommodated therein.

Although the foregoing embodiments of the present disclosure have been disclosed for illustrative purposes, those of ordinary skill in the art should appreciate that various modifications, additions, and substitutions are possible, without departing from the scope and spirit of the disclosure as disclosed in the accompanying claims.

What is claimed is:

1. A battery pack for vehicles, the battery pack comprising:
a lower case including a module accommodation space defined therein to accommodate a plurality of battery modules;
at least one longitudinal member provided in the module accommodation space in the lower case and arranged to be elongate in a forward-rearward direction; and
a mounting through-hole formed in the at least one longitudinal member to allow a through-bolt to be inserted therethrough for mounting the battery pack.

2. The battery pack according to claim 1, further comprising a transverse member provided in the module accommodation space in the lower case and arranged in a direction perpendicular to the at least one longitudinal member.

3. The battery pack according to claim 2, wherein the mounting through-hole is not formed in the transverse member.

4. The battery pack according to claim 1, further comprising a through pipe member mounted in the mounting through-hole,
wherein the through pipe member is disposed to allow the through-bolt to pass therethrough in order to support fastening force of the through-bolt.

5. The battery pack according to claim 1, wherein
the module accommodation space in the lower case is a rectangular parallelepiped shape, and
the at least one longitudinal member is mounted so as to be connected between a front surface of the module accommodation space and a rear surface of the module accommodation space.

6. The battery pack according to claim 5, wherein
the lower case comprises an extension space defined therein at at least one of a position ahead of the module accommodation space or a position behind the module accommodation space, and
the extension space is a separate space extending forward or rearward from the module accommodation space.

7. The battery pack according to claim 6, wherein
the lower case comprises battery side members provided on both sides of the module accommodation space, and
the battery side members are connected at end portions thereof to a peripheral member that defines the extension space.

8. A mounting structure for a vehicular battery pack, the mounting structure comprising:
a lower case including a module accommodation space defined therein to accommodate a plurality of battery modules;
at least one longitudinal member provided in the module accommodation space in the lower case and arranged to be elongate in a forward-rearward direction;
at least one cross-member mounted to a vehicle body and arranged to be elongate in a transverse direction of the vehicle body; and
a through-bolt fastened through the at least one longitudinal member and the at least one vehicle body cross-member.

9. The mounting structure according to claim 8, further comprising:
a mounting through-hole formed in the at least one longitudinal member to allow the through-bolt to be inserted therethrough; and
a through pipe mounted in the mounting through-hole,
wherein the through pipe is formed to allow the through-bolt to pass therethrough in order to support fastening force of the through-bolt.

10. The mounting structure according to claim 9, further comprising a transverse member provided in the module accommodation space in the lower case and arranged in a direction perpendicular to the at least one longitudinal member,
wherein the mounting through-hole is formed in the at least one longitudinal member.

11. The mounting structure according to claim 8, wherein the at least one cross-member comprises a seat cross-member provided for mounting of a seat, and
wherein the through-bolt is fastened through the seat cross-member.

12. The mounting structure according to claim 11, wherein:
the seat cross-member is mounted above a floor panel of the vehicle body;
the mounting structure further comprises a weld nut fixedly provided between the seat cross-member and the floor panel; and
the battery mounting through-bolt is fastened to the weld nut.

13. The mounting structure according to claim 8, wherein:
the module accommodation space in the lower case is a rectangular parallelepiped shape; and
the at least one longitudinal member is mounted so as to be connected between a front surface of the module accommodation space and a rear surface of the module accommodation space.

14. The mounting structure according to claim 13, wherein
the lower case comprises an extension space defined therein at at least one of a position ahead of the module accommodation space or a position behind the module accommodation space, and
the extension space is a separate space extending forward or rearward from the module accommodation space.

15. The mounting structure according to claim 14, wherein:
the lower case includes battery side members provided on both sides of the module accommodation space;
the battery side members are connected at end portions thereof to a peripheral member that defines the extension space; and
the battery side members include a plurality of side mounting holes formed therein to couple the battery side members to the vehicle body.
